(19) United States
(12) Patent Application Publication
(10) Pub. No.: US 2008/0309604 A1
(43) Pub. Date: Dec. 18, 2008

(54) Liquid crystal display having polarity analyzing unit for determining polarities pixels thereof

(75) Inventor: Shun-Ming Huang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/214,181

(22) Filed: Jun. 16, 2008

(30) Foreign Application Priority Data
Jun. 15, 2007 (CN) 200710075050.6

(51) Int. Cl. G09G 3/36

(52) U.S. Cl. 345/90

(57) ABSTRACT

A liquid crystal display (300) includes a liquid crystal panel (310) having a plurality of pixels P_{(i, j)} arranged in a matrix, a brightness identification unit (343) configured for identifying a brightness of an image element to be displayed by at least one pixel, a polarity analyzing unit (344) configured for analyzing a result of the identification, and a data circuit (330). The polarity analyzing unit is also configured for generating a composed binary signal having a first binary portion the same as the primary display signal and an additive second binary portion. The data circuit is configured to provide a data voltage to drive the pixel according to the signal. A value of the data voltage is determined by a first binary portion of the composed binary signal, and a polarity of the pixel is determined by the second binary portion of the composed binary signal.

### FIELD OF THE INVENTION

Embodiments of the present disclosure relate to liquid crystal displays (LCDs), and more particularly to an LCD employing a polarity analyzing unit to determine polarities of pixels thereof.

### GENERAL BACKGROUND

LCDs are widely used in various information products, such as notebooks, personal digital assistants, video cameras, and the like. A conventional LCD utilizes liquid crystal molecules to control light transmission in each pixel of the LCD. In general, the conventional LCD employs an inversion system, such as a frame inversion system, for example, to drive the liquid crystal molecules.

FIG. 3 illustrates a series of polarity patterns of the pixels of a conventional LCD which employs the frame inversion system. In order to simplify the following explanation, only a 4-by-4 sub-matrix of pixels of the LCD is shown. As shown in FIG. 3, polarities of all the pixels are the same in each frame period, and the polarity of each pixel is inverted to an opposite polarity in a subsequent frame period. For example, the polarities of all the pixels are positive in the Nth frame period, and are inverted to be negative in the (N+1)th frame period.

By employing the frame inversion system, the LCD can be protected from what is known as “burn in” where continual operation of the video signal causes damage to the LCD. However, because the polarities of all the pixels are the same in each frame period, and are simultaneously inverted in the subsequent frame period, a user may perceive that an image displayed by the LCD is skipping during the inversion of the polarities of the pixels. Thereby, a so-called flicker phenomenon is generated in the LCD, and the display quality of the LCD is unsatisfactory.

From the foregoing, it should be appreciated that there is a need for an LCD to overcome the “burn-in” effect. To this end, there is a need for an LCD to overcome the so-called flicker phenomenon.

### SUMMARY

In one aspect, a liquid crystal display includes a plurality of pixels arranged in a matrix, a brightness identification unit configured for identifying a brightness of an image element to be displayed by at least one pixel from the plurality of pixels, a polarity analyzing unit configured for analyzing a result of the identification, and for generating a composed binary signal, and a data circuit configured to provide a data voltage to drive the at least one pixel according to the composed binary signal. The brightness of the image element is determined by a corresponding primary display signal. The composed binary signal having a first binary portion the same as the primary display signal and an additive second binary portion. A value of the data voltage is determined by the first binary portion of the composed binary signal, and a polarity of the at least one pixel is determined by the second binary portion of the composed binary signal.

In another aspect, a liquid crystal display includes a plurality of pixels, a brightness identification unit, a polarity analyzing unit, and a data circuit. Each pixel corresponds to a first signal having a bright state or a dark state. The brightness identification unit is configured for identifying the first signal of each pixel. The polarity analyzing unit is configured for analyzing a result of the identification in order to generate a second signal having an additive portion. The data circuit is configured to provide a data voltage to drive the pixel according to the second signal. A value of the data voltage is determined by the first signal, and a polarity of the pixel is determined by the additive portion of the second signal.

Other novel features and advantages will become more apparent from the following detailed description when taken in conjunction with the accompanying drawings.

### BRIEF DESCRIPTION OF THE DRAWINGS

FIG. 1 is essentially an abbreviated circuit diagram of an LCD according to one embodiment of the present disclosure, the LCD including a data circuit.

FIG. 2 is an abbreviated circuit diagram of the data circuit of the LCD of FIG. 1.

FIG. 3 illustrates a series of polarity patterns of pixels of a conventional LCD which employ a frame inversion driving system.

### DETAILED DESCRIPTION OF CERTAIN INVENTIVE EMBODIMENTS

Reference will now be made to the drawings to describe certain embodiments of the present disclosure in detail.

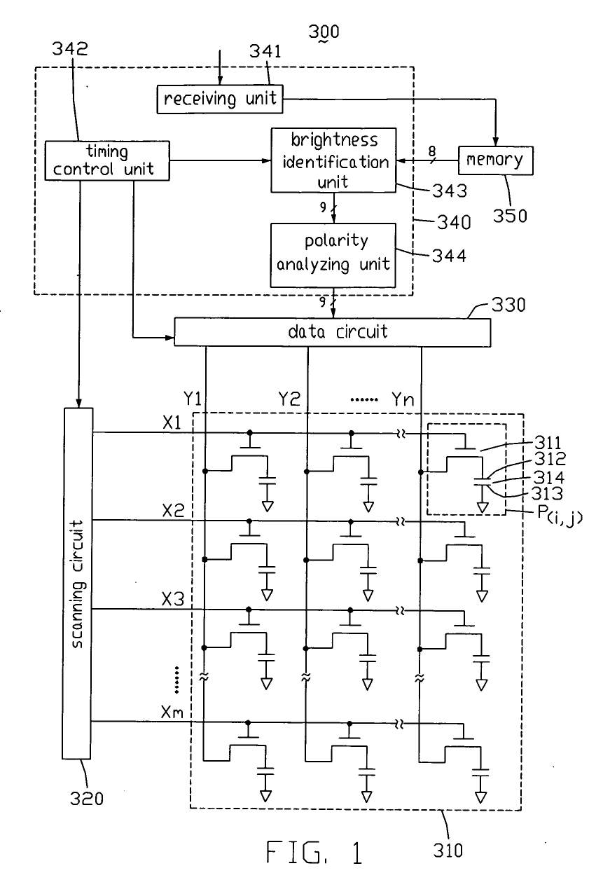

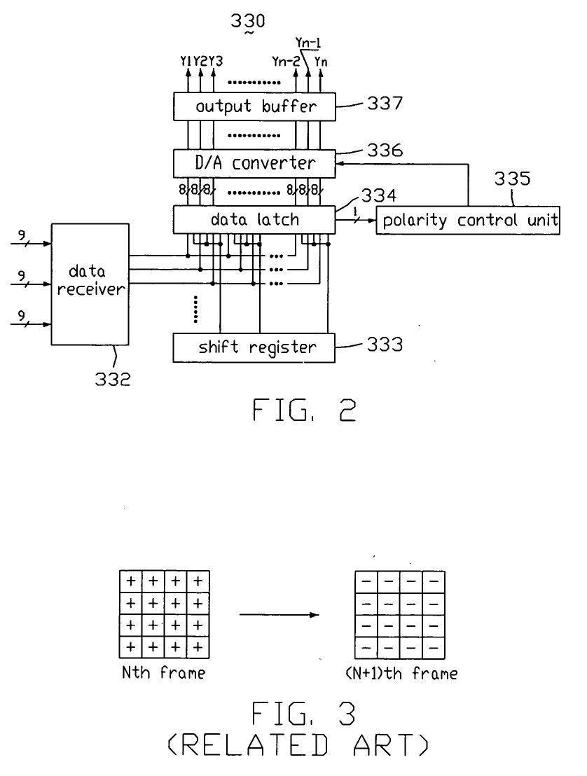

FIG. 1 is essentially an abbreviated circuit diagram of an LCD according to one embodiment of the present disclosure. The LCD 300 includes a liquid crystal panel 310, a scanning circuit 320, a data circuit 330, a timing controller 340, and a memory 350.

The liquid crystal panel 310 includes m rows of parallel scanning lines X1˜Xm (where m is a natural number), n columns of parallel data lines Y1˜Yn (where n is also a natural number) perpendicular to the scanning lines X1˜Xm, and a plurality of pixels P_{(i, j)} (where i, j are both natural numbers, 1≦i≦m, 1≦j−n) cooperatively defined by the crossing scanning lines X1˜Xm and data lines Y1˜Yn. Thereby, the pixels P_{(i, j)} are arranged in a matrix having m rows and n columns. The scanning lines X1˜Xm are electrically coupled to the scanning circuit 320, and the data lines Y1˜Yn are electrically coupled to the data circuit 330. In the liquid crystal panel 310, each pixel P_{(i, j)} has a respective address corresponding to a digital address signal. The digital address signal includes a horizontal address code indicating which row the pixel P_{(i, j)} is located in, and a vertical address code indicating which column the pixel P_{(i, j)} is located in. In the following description, P_{(i, j)} refers to the pixel located in the (i)th row and (j)th column of the matrix.

Each pixel P_{(i, j)} includes a thin-film transistor (TFT) 311, a pixel electrode 312, and a common electrode 313. A gate electrode of the TFT 311 is electrically coupled to a corresponding one of the scanning lines X1˜Xm, and a source electrode of the TFT 311 is electrically coupled to a corresponding one of the data lines Y1˜Yn. Furthermore, a drain electrode of the TFT 311 is electrically coupled to the pixel electrode 312. The common electrode 313 is generally opposite to the pixel electrode 312, with a plurality of liquid crystal molecules (not shown) sandwiched therebetween, so as to cooperatively form a liquid crystal capacitor 314.

The timing controller 340 includes a receiving unit 341, a timing control unit 342, a brightness identification unit 343, and a polarity analyzing unit 344. The receiving unit 341 is configured to receive digital display signals from an external circuit (not shown), and store the digital display signals in the memory 350. The timing control unit 342 is configured to control drive timings of the scanning circuit 320, the data circuit 330, and the brightness identification unit 343. The brightness identification unit 343 is configured to identify a brightness of a color to be displayed by each pixel P_{(i,} j) according to the corresponding digital display signal. Furthermore, the brightness identification unit 343 is configured to provide a brightness sign bit B1 to the display signal according to a result of the brightness identification. The polarity analyzing unit 344 is configured to analyze the brightness sign bit B1, and correspondingly convert the brightness sign bit B1 into a polarity control bit B2. The polarity analyzing unit 344 includes an inner register (not shown).

Referring to FIG. 2, the data circuit 330 is configured to provide a data voltage to drive one or more pixels according to a signal generated by the polarity analyzing unit 344. In one embodiment, the data circuit 330 includes a data receiver 332, a shift register 333, a data latch 334, a polarity control unit 335, a digital to analog (D/A) converter 336, and an output buffer 337. The data receiver 332 is configured to receive the display signals with the polarity control bits B2 from the polarity analyzing unit 344. The shift register 333 is configured to generate a plurality of shift pulses according to a timing control signal received from the timing control unit 342, and send the shift pulses to the data latch 334. The data latch 334 is configured to receive the display signals with the polarity control bits B2 from the data receiver 332 according to the shift pulses, and separate the polarity control bit B2 from the corresponding display signal. The polarity control unit 335 is configured to provide a polarity control signal according to the polarity control bit B2. The D/A converter 336 is configured to convert each display signal into a data voltage having a polarity that is determined by the polarity control signal. The output buffer 337 is configured to output the data voltages to the pixels P_{(i, j)} via the data lines Y1˜Yn.

Operation of the LCD 300 is as follows. To simplify the following description, only an operation of the (i)th row of pixels P_{(i, j)} of the LCD 300 in an Nth frame period is taken as an example. However, it may be understood that a similar operation may take place according to any row of the pixels P_{(i, j)} and in any frame period. In addition, the following definitions and labels may be defined. A primary display signal D0_{(i, j)} refers to a digital display signal corresponding to the pixel P_{(i, j)} received by the receiving unit 341 in the Nth frame period. A brightness sign bit B1_{(i, j)} refers to one of the brightness sign bits B1 corresponding to the pixel P_{(i, j)} provided by the brightness identification unit 343 in the Nth frame period. A polarity control bit B2_{(i, j)} refers to one of the polarity control bits B2 corresponding to the pixel P_{(i, j)} provided by the polarity analyzing unit 344 in the Nth frame period. A polarity control bit B2*_{(i, j)} refers to one of the polarity control bits B2 corresponding to the pixel P_{(i, j)} in an (N−1)th frame period. A first display signal D1_{(i, j)} refers to the primary display signal D0_{(i, j)} with the brightness sign bit B1_{(i, j)}. A second display signal D2_{(i, j)} refers to the primary digital display signal D0_{(i, j)} with the polarity control bit B2_{(i, j)}.

Moreover, the pixel P_{(i, j)} is defined as having a positive polarity when the data voltage received by the pixel electrode 312 is greater than a reference voltage (usually named as a common voltage generated by a common voltage circuit (not shown)) received by the common electrode 313. Conversely, the pixel P_{(i, j)} is defined as having a negative polarity when the data voltage is lower than the reference voltage.

The receiving unit 341 may receive digital display signals from an external circuit (not shown) and output the digital display signals to the timing controller 340 in the Nth frame period. The receiving unit 341 may further output the primary display signal D0_{(i, j)} to the memory 350. In particular, each primary display signal D0_{(i, j)} is an 8-bit digital signal selected from the binary numbers 00000000˜11111111, corresponding to one of 256 gray levels.

The brightness identification unit 343 receives and processes the primary display signal D0_{(i, j)} under the control of an internal timing control signal provided by the timing control unit 342. The brightness identification unit 343 then recognizes a value of each primary display signal D0_{(i, j)} to identify a brightness of a color to be displayed by the corresponding pixel P_{(i, j)}, and accordingly generates a corresponding brightness sign bit B1_{(i, j)}. For example, when the primary display signal D0_{(i, j)} is in a range from 00000000˜01110111, the primary display signal D0_{(i, j)} corresponds to a gray level selected from the first to the 119th gray level. The brightness identification unit 343 identifies the primary display signal D0_{(i, j)} as being a dark signal (i.e. in a dark state), and provides a brightness sign bit B1_{(i, j)} equal to 0 to the primary display signal D0_{(i, j)}. In another example, when the primary display signal D0_{(i, j)} is in a range from 01111000˜11111111, the primary display signal D0_{(i, j)} corresponds to a gray level selected from the 120th to the 256th gray level. The brightness identification unit 343 identifies the primary display signal D0_{(i, j)} as being a bright signal (i.e. in a bright state, and provides a brightness sign bit B1_{(i, j)} equal to 1 to the primary display signal D0_{(i, j)}. The brightness sign bit B1_{(i, j)} is added to the primary display signal D0_{(i, j)} and treated as an independent most significant bit (i.e. the ninth bit) of the primary display signal D0_{(i, j)}. Thus, the 8-bit primary display signal D0_{(i, j)} is converted into a 9-bit first display signal D1_{(i, j)}. For example, the corresponding first display signal D1_{(i, j)} is 000000001 when the primary display signal D0_{(i, j)} is 00000001. It may be appreciated that the bright state and the dark state may refer to an intensity of the corresponding gray levels of the primary display signal D0_{(i, j)}.

To convert the brightness sign bit B1_{(i, j)} of the first display signal D1_{(i, j)} into a polarity control bit B2_{(i, j)}, the polarity analyzing unit 344 receives the first display signal D1_{(i, j)}, and reads a corresponding vertical address code of the target pixel P_{(i, j)} from an address register (not shown) of the LCD 300. The polarity analyzing unit 344 may then convert the brightness sign bit B1_{(i, j)} of the first display signal D1_{(i, j)} into a polarity control bit B2_{(i, j)}. Details of the conversion are explained as follows.

In one example, when the vertical address code indicates that the target pixel P_{(i, j)} is located in the first column of the matrix (i.e. j=1), the target pixel P_{(i, j)} is relabeled as P_{(i, 1)}, and a polarity control bit B2*_{(i, 1)} of the target pixel P_{(i, 1)} in the (N−1)th frame period is treated as a polarity inversion reference. Subsequently, the polarity analyzing unit 344 reads the polarity control bit B2*_{(i, 1)} from the inner register, and generates a corresponding polarity control bit B2_{(i, 1)} having an opposite polarity to the polarity control bit B2*_{(i, 1)}. The polarity control bit B2_{(i, 1)} then replaces the brightness sign bit B1_{(i, 1)}, such that the first display signal D1_{(i, 1)} is converted into a second display signal D2_{(i, 1)}. For example, if the polarity control bit B2*_{(i, 1)} is equal to 1, the polarity control bit B2_{(i, 1)} of the second display signal D2_{(i, 1)} is equal to 0; and vice versa.

In another example, when the vertical address code indicates that the target pixel P_{(i, j)} is not located in the first column of the matrix (i.e. 2≦j≦n), and the brightness sign bit B1_{(i, j)} of the first display signal D1_{(i, j)} is equal to 0, the polarity analyzing unit 344 treats the polarity control bit B2_{(i, j-1)} of the previous pixel P_{(i, j-1)} as a inversion reference. Subsequently, the polarity analyzing unit 344 generates a corresponding polarity control bit B2_{(i, j)} having an opposite polarity to the polarity control bit B2_{(i, j-1)}. For example, if the polarity control bit B2_{(i, j-1)} is equal to 1, the polarity control bit B2_{(i, j)} of the second display signal D2_{(i, j)} is equal to 0; and vice versa. Similarly, the first display signal D1_{(i, j)} is then converted into a second display signal D2_{(i, j)}, with the brightness sign bit B1(_{i, j)} being replaced by the polarity control bit B2_{(i, j)}.

In another example, when the vertical address code indicates that the target pixel P_{(i, j)} is not located in the first column of the matrix, and the brightness sign bit B1_{(i, j)} of the first display signal D1_{(i, j)} is equal to 1, the polarity analyzing unit 344 analyzes whether the first display signal D1_{(i, j)} is the first bright signal in the (i)th row of pixels P_{(i, j)} (e.g. the brightness sign bits B1_{(i, 1)}˜B1_{(i, j-1)} are all equal to 0, and the brightness sign bit B1_{(i, j)} is equal to 1). If the first display signal D1_{(i, j)} is the first bright signal in the (i)th row of pixels P_{(i, j),} then the brightness sign bit B1_{(i, j)} of the first display signal D1_{(i, j)} is maintained and treated as the polarity control bit B2_{(i, j)}. Accordingly, the first display signal D1_{(i, j)} serves as the corresponding second display signal D2_{(i, j)} without any conversion.

If the brightness sign bits B1_{(i, 1)}˜B1_{(i, j-1)} are not all equal to 0, (e.g. at least one of the brightness sign bits B1_{(i, k)} (1≦k≦j−1) is equal to 1), assuming that a maximum value of k is q, a color to be displayed by a target pixel P_{(i, q)}, of the first display signal D1_{(i, q)} (1≦q≦k), is in a bright state. In this situation, the polarity analyzing unit 344 treats the polarity control bit B2_{(i, q)} as a polarity inversion reference, and generates a corresponding polarity control bit B2_{(i, j)} having an opposite polarity to the polarity control bit B2_{(i, q)}. The polarity control bit B2_{(i, j)} then replaces the brightness sign bit B1_{(i, j)}, such that the first display signal D1_{(i, j)} is converted into a second display signal D2_{(i, j)}.

To simplify the above description, an example is provided. In one example, when the brightness sign bits B1_{(i, 1)}˜B1_{(i, 7)} of the first display signals D1_{(i, 1)}˜D1_{(i, 7)} corresponding to the first to seventh pixels P_{(i, 1)}˜P_{(i, 7)} of the (i)th row of the matrix are respectively 0, 1, 0, 0, 1, 1, and 0, the polarity control bits B2_{(i, 1)}˜B2_{(i, 7)} generated by the polarity analyzing unit 344 are respectively 0, 1, 0, 1, 0, 1, and 0. Furthermore, when the first display signal D1_{(i, j)} is converted to the second display signal D2_{(i, j)}, the polarity control bit B2_{(i, j)} is outputted and stored in the inner register of the polarity analyzing unit 344.

Similarly, other primary display signals D0_{(i, j)} of the same row of pixel P_{(i, j)} are then converted to the corresponding second display signals D2_{(i, j)} sequentially. All the second display signals D2_{(i, j)} are further outputted to the data receiver 332 of the source driver 330. The data latch 334 receives each of the second display signals D2_{(i, j)} according to a respective shift pulse provided by the shift register 333, and then distributes the polarity control bit B2_{(i, j)} (i.e. the ninth bit of the second display signal D2_{(i, j)}) to the polarity control unit 335. Furthermore, the data latch 334 distributes the primary display signal D0_{(i, j)} (i.e. the least significant eight bits of the second display signal D2_{(i, j)}) to the D/A converter 336. The polarity control unit 335 provides a corresponding polarity control signal to the D/A converter 336 according to the polarity control bit B2_{(i, j)}. The D/A converter 336 then converts each primary display signal D0_{(i, j)} to a data voltage having the corresponding polarity. In particular, the data voltage has a positive polarity when the polarity control bit B2_{(i, j)} is equal to 1, and has a negative polarity when the polarity control bit B2_{(i, j)} is equal to 0.

The data voltages corresponding to all the pixels P_{(i, j)} in the (i)th row of the matrix are then simultaneously outputted to the pixels P_{(i, j)} via the output buffer 337 and the corresponding data lines Yⱼ. In addition, the (i)th row of pixels P_{(i, j)} are activated by a scanning signal outputted from the scanning circuit 320 before the data voltages are applied thereto. Each of the data voltages then charges the corresponding liquid crystal capacitor 341 thereby generating an electric field between the pixel electrode 312 and the common electrode 313. The generated electric field drives the liquid crystal molecules to tilt to corresponding angles thereby displaying a particular color at the pixel P_{(i, j)}.

After the pixel P_{(i, j)} generates the particular color, the (i+1)th to (m)th rows of pixels 340 are activated to display corresponding colors sequentially during the Nth frame period. It may be understood that the driving process for each row is similar to the above-described Xth row of pixels 340. Each color serves as an image element, and the aggregation of the image elements displayed by all the pixels P_{(i, j)} of the LCD 300 simultaneously constitutes an image viewed by a user.

In summary, the LCD 300 employs the brightness identification unit 343 to identify the brightness of a color to be displayed by the each pixel P_{(i, j)}. The LCD 300 further employs the polarity analyzing unit 344 to determine a polarity of the pixel P_{(i, j)} according to an identification result and an address code of the pixel P_{(i, j)}. Thus, the polarities of all the pixels P_{(i, j)} are prevented from being the same in each frame period. When the polarities of the pixels P_{(i, j)} are inverted, a portion of the pixels P_{(i, j)} have their polarities change from positive to negative, while the rest of the pixels P_{(i, j)} have their polarities change from negative to positive. Thus, the skipping of images displayed by the LCD 300, that might otherwise exist, can be reduced or even eliminated. Accordingly, the so-called flicker phenomenon can be diminished or even eliminated, thus improving the display quality of the LCD 300.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of arrangement of parts) within the principles of the invention to the full extent indicated by the broad general meaning of the terms in which the appended claims are expressed.

What is claimed is:

1. A liquid crystal display, comprising:
a liquid crystal panel comprising a plurality of pixels arranged in a matrix;
a brightness identification unit configured for identifying a brightness of an image element to be displayed by at least one pixel from the plurality of pixels, wherein the brightness of the image element is determined by a corresponding primary display signal;
a polarity analyzing unit configured for analyzing a result of the identification, and for generating a composed binary signal, the composed binary signal having a first binary portion the same as the primary display signal and an additive second binary portion; and
a data circuit configured to provide a data voltage to drive the at least one pixel according to the composed binary signal;
wherein a value of the data voltage is determined by the first binary portion of the composed binary signal, and a polarity of the at least one pixel is determined by the second binary portion of the composed binary signal.

2. The liquid crystal display of claim 1, wherein the brightness identification unit converts the primary display signal to a converted display signal by providing an additive brightness sign bit.

3. The liquid crystal display of claim 2, wherein the additive brightness sign bit is an independent bit from the primary display signal in the converted display signal.

4. The liquid crystal display of claim 2, wherein the additive brightness sign bit is a most significant bit of the converted display signal.

5. The liquid crystal display of claim 2, wherein the image element is identified as in a dark state when a value of the primary display signal is in a predetermined range, and the image element is identified as in a bright state when the value of the primary display signal is out of the predetermined range.

6. The liquid crystal display of claim 5, wherein the additive brightness sign bit has a first value when the image element is identified as in a dark state, and has a second value when the image element is identified as in a bright state.

7. The liquid crystal display of claim 6, wherein the additive brightness sign bit is converted to a polarity control bit by the polarity analyzing unit, and the polarity control bit is configured as the second binary portion of the composed binary signal.

8. The liquid crystal display of claim 7, wherein the polarity control bit is determined by at least one of the brightness sign bit and a location of a corresponding pixel.

9. The liquid crystal display of claim 8, wherein the polarity control bit is of an opposite polarity to a polarity in a corresponding pixel in a previous frame period when the at least one pixel is located in a first column of the matrix.

10. The liquid crystal display of claim 8, wherein the polarity control signal is of an opposite polarity to a polarity in a corresponding nearest previous pixel of a same row of the matrix when the at least one pixel is not located in the first column of the matrix and the brightness signal bit has the first value.

11. The liquid crystal display of claim 8, wherein the polarity control bit is of a same polarity as a polarity of a corresponding additive brightness signal bit when the at least one pixel is not located in the first column of the matrix, wherein the corresponding additive brightness signal bit has the second value, and wherein the additive brightness signal bit corresponding to all previous pixels of a same row of the matrix have the first value.

12. The liquid crystal display of claim 8, wherein the polarity control bit is of an opposite polarity to a polarity of a corresponding nearest pixel whose additive brightness sign bit has a second value when the at least one pixel is not located in the first column of the matrix, the corresponding additive brightness signal bit has the second value, and at least one of the additive brightness signal bits corresponding to all previous pixels of a same row of the matrix has the second value.

13. The liquid crystal display of claim 1, further comprising a receiving unit, the receiving unit configured to receive the primary display signals.

14. The liquid crystal display of claim 13, further comprising a timing control unit, the timing control unit configured to control a drive timing of the data circuit and the additive brightness identification unit.

15. The liquid crystal display of claim 14, further comprising a memory, the memory configured to store the primary display signal received by the receiving unit.

16. The liquid crystal display of claim 1, wherein the data circuit comprises a data latch, the data latch configured to separate the second binary portion of the composed binary signal from the first portion of the composed binary signal.

17. The liquid crystal display of claim 16, wherein the data circuit further comprises a polarity control unit, wherein the polarity control unit is configured to provide a polarity control signal according to the second portion of the composed binary signal.

18. The liquid crystal display of claim 17, wherein the data circuit further comprises a digital to analog converter configured to convert the first portion of the composed binary signal to the data voltage, and wherein a polarity of the data voltage is determined by the polarity control signal.

19. A liquid crystal display, comprising:
a plurality of pixels, each pixel corresponding a first signal having a bright state or a dark state;
a brightness identification unit configured for identifying the first signal of at least one pixel;
a polarity analyzing unit configured for analyzing a result of the identification in order to generate a second signal having an additive portion; and
a data circuit configured to provide a data voltage to drive the at least one pixel according to the second signal;
wherein a value of the data voltage is determined by the first signal, and a polarity of the at least one pixel is determined by the additive portion of the second signal.
